(19) United States
(12) Patent Application Publication
(10) Pub. No.: US 2004/0260464 A1
(43) Pub. Date: Dec. 23, 2004

(54) Point of interest (POI) search method and apparatus for navigation system

(76) Inventor: Winnie Wong, Redondo Beach, CA (US)

Correspondence Address: MURAMATSU & ASSOCIATES, Suite 225, 7700 Irvine Center Drive, Irvine, CA, 92618, US

(21) Appl. No.: 10/601,905

(22) Filed: Jun. 23, 2003

(51) Int. Cl. G01C 21/34

(52) U.S. Cl. 701/209; 340/995.19

(57) ABSTRACT

A “Point of Interest (POI)” search method for navigation system in which POIs are searched through a search-by-street method which can be used at any stage of the conventional POI search process. The POI search method includes the steps of starting a POI search process where POIs are selectable either by a place type of a place name, specifying a name of a street to retrieve POIs along the street, and displaying a list of POIs retrieved along the street to select one of them. The search process further includes a step of specifying a name of a city, thereby retrieving POIs along the specified street within the specified city. The search process further includes a step of specifying a first intersection of the street and a second intersection of the street, thereby retrieving POIs along the specified street between the first and second intersections.

### FIELD OF THE INVENTION

This invention relates to a “Point of Interest (POI)” search method for navigation system for guiding a user to a destination, and more particularly, to a search-by-street method and apparatus incorporated during the POI search process for efficiently and easily searching desired POIs by specifying street names and other parameters and selecting the destination.

### BACKGROUND OF THE INVENTION

A navigation system performs travel guidance for enabling a user to easily and quickly reach the selected destination. A typical example is a vehicle navigation system where a user drives a car having a navigation system to a destination. Such a navigation system detects a position of a user or user's vehicle, reads out map data pertaining to an area at the current vehicle position from a data storage medium, for example, a CD-ROM (compact disc read-only memory), a DVD (digital versatile disc), or a hard disc. Alternatively, such map data can be provided to the user from a remote server through a communication network such as Internet. The navigation system displays a map image on a monitor screen while superimposing a mark representing the current location of the user on the map image.

When a destination is set, the navigation system starts a route guidance function for setting a guided route from the start point to the destination. To determine the guided route to the destination, the navigation system calculates and determines an optimum route to the destination based on various parameters. For example, the guided route is determined based on the shortest way to reach the destination, the route preferring freeways to surface roads, the least expensive way to the destination, or the route without using toll road, or the like.

During the route guidance, the navigation system reads the nodes data from the data storage medium such as DVD and successively stores the nodes data of road segments (expressed in longitude and latitude) constituting the guided route in a memory. In the actual traveling, the node series stored in the memory is searched for a portion of the guided route to be displayed in a map display area of the monitor screen, and the portion of the guided route is highlighted so as to be discriminable from other routes. When the vehicle is within a predetermined distance of an intersection it is approaching, an intersection guidance diagram (an enlarged or highlighted intersection diagram with an arrow indicating the direction in which the vehicle is to turn at the intersection) is displayed to inform a user of the desired one of roads or directions selectable at the intersection. Such route guidance by the navigation system is also given by voice instruction.

FIGS. 1A-1H show an example of overall procedure and screen display involved in the navigation system. FIG. 1A shows an example of locator map screen of the navigation system when the destination is not specified. Typically, the navigation system displays a street on which the vehicle (current vehicle position VP) is running on a map image and a name of the street. Other information such as a north pointer NP, a map scale and a current time may also be illustrated on the display screen. In this situation, the navigation system does not perform the route guidance function because the destination is not specified.

FIGS. 1B-1F show an example of process for specifying a destination in the navigation system. When selecting a “Destination” menu on a main menu screen (not shown), the navigation system displays an “Find Destination By” screen as shown in FIG. 1B for specifying an input method for selecting the destination. The “Find Destination By” screen lists various methods for selecting the destination. The methods include “Address” for specifying the city and address of the destination, “Intersection” for specifying the names of two streets which intersect with one another, and “Point of Interest” (POI) for selecting the programmed destination based on the name, category or telephone number. Other methods in the “Find Destination By” screen include “Recent Route” for specifying the destination based on the recent history of destinations saved in the navigation system, “Address Book” for selecting the address of the destination out of the prescribed address list stored in the system, and “Today's Plan” for selecting two or more destinations.

When selecting, for example, the “Point of Interest” method in FIG. 1B, the navigation system displays selection methods of point of interest (POI) either by “Place Name” or “Place Type” in FIG. 1C. The “Place Name” is to specify a name of POI, and the “Place Type” is to specify a category of POI. If the “Place Type” is selected in FIG. 1C, the navigation system shows an “Select Category” screen such as shown in FIG. 1D. The screen of FIG. 1D lists categories of POI such as “ATM”, “BanK”, “Gas Station”, “Hospital”, “Movie Theater”, and “Restaurant”.

Suppose the user selects “Restaurant”, the navigation system retrieves the POIs in the selected category, restaurant, in this case, as shown in FIG. 1E. Typically, POIs (restaurants) will be listed in the order of distance from the user (ex. current vehicle position). If the user selects a particular restaurant from the list, such as “Genkai”, the navigation system displays a “Confirm Route” screen such as shown in FIG. 1F. In this example, the “Confirm Route” screen lists the name, address and phone number of the destination (POI specified by the user). If this is the correct destination, the user enters an “OK to Proceed” key to proceed to the next procedure.

In FIG. 1G, the navigation system calculates and determines a route to the destination, i.e., the selected POI. The navigation system determines a route to the destination based on, for example, the shortest way to reach the destination, the route using many free ways as possible or the route without using toll road, and the like. In this example, the navigation system displays a progress scale of the calculation of the route.

After determining the guided route, the navigation system starts the route guidance as shown in FIG. 1H to guide the user along the calculated route to the destination. Typically, the navigation system shows the intersection which is highlighted to show the next turn and a direction of the turn. Such route guidance by the navigation system is also accompanied by voice instructions.

As described in the foregoing, the “Point of Interest (POI)” method is a convenient way for selecting a destination because POIs can be searched by specifying a category, subcategory, or a name, and such POIs can be sorted by various ways. Further, in the present day technology, there is a type of navigation system which is designed to display POIs on a monitor screen, typically with use of POI icons, in a manner superimposed on a map image such as shown in FIGS. 2A-2C. In such an application, a user can select a POI icon on the map image so that the navigation system shows detailed information on the selected POI.

For example, in FIG. 2A, the navigation system displays a calculated route connecting a current position of a user (ex. vehicle position VP) to a destination, and POI icons 1-9 along the calculated route. Typically, the POI icons are searched within a predetermined short distance from the calculated route such as a half mile. In the example of FIG. 2B, the navigation system searches and displays POI icons 1-8 around a map cursor CR. In the example of FIG. 2C, the navigation system searches and displays POI icons 1-8 around a current user location such as a vehicle position VP. In the foregoing examples of FIGS. 2A-2C, the user can specify one or more categories of POIs to be searched.

As described above, various methods using POIs are available in the existing navigation systems. However, the existing methods are still not sufficient for a user to fully use the POI data. As an example, a recent DVD for a navigation system stores about nine millions of POIs which are classified to about 230 categories and sub-categories. Thus, it is desired to more effectively make use of such a large database. Further, although there are various methods, the current POI input method is still restrictive, and sometimes not user-friendly.

For example, suppose that a user forgets a place name of the destination but remembers only a street name of a particular POI. In such a case, the existing POI input method does not have a way to easily find the POI based on the street name known to the user. Accordingly, the present day POI input method sometimes requires a long time to finally find the desired POI to specify the destination, which may adversely affect the safe driving. Thus, there is a need for a new method and apparatus for use with a navigation system which can easily and quickly find a POI and specify the destination through the POI input method.

### SUMMARY OF THE INVENTION

It is, therefore, an object of the present invention to provide a navigation system which enables a user to more easily and effectively search a preferred POI with use of a search-by-street method when using a “Point of Interest (POI)” input method to define the destination in the navigation system.

It is another object of the present invention to provide a navigation system which performs a POI search process with high flexibility by incorporating a search-by-street method any time during the POI search process.

It is a further object of the present invention to provide a navigation system which performs a search-by-street method by specifying a street name, and if necessary, a city name, and two cross streets for retrieving POIs along the entire street, along the street within the city, or along the street within the two cross streets.

In the preferred embodiment of the present invention, there are three types of the search-by-street method. The first type searches and produces a POI name list containing POIs along an entire street. The second type searches and produces a POI name list containing POIs along the street only within a city. The third type searches and produces a POI name list containing POIs along the street only between two intersecting streets. In the search-by-street method, the user specifies the street name, and if necessary, the city name, or the two intersecting streets.

More specifically, the point of interest (POI) search method for a navigation system comprises the steps of starting a POI search process, specifying a name of a street to retrieve POIs along the street, and displaying a list of POIs retrieved along the street to select one of them. Typically, the search process further includes the step of specifying a type of POIs to be retrieved and the step of specifying a name of POI to be retrieved.

As a result of specifying the name of the street, the navigation system retrieves POIs along the entire length of the specified street. Preferably, the search process further includes a step of specifying a name of a city in addition to the street name, thereby retrieving POIs along the specified street within the specified city. Preferably the search process further includes a step of specifying a first intersection of the street and a second intersection of the street, thereby retrieving POIs along the specified street between the first and second intersections.

Another aspect of the present invention is a POI search apparatus for a navigation system. The POI search apparatus is constituted by various means for achieving the POI search method described above which searches POIs along the specified street (search-by-street). The range of search for the specified street may be limited to within a city or between two intersections. The search-by-street method can be used at any stage of the POI search process.

According to the present invention, the vehicle navigation system enables the user to more effectively and easily find a POI to specify the destination by incorporating the search-by-street method in the POI search process. Because the user can designate a street name, a city name, and two intersecting streets during the search process, he can quickly access a POI list which contains the desired POI. The search-by-street process can be used in various stages of the POI search process. Thus, the user can choose the search-by-street method any time during the search process based on the specific situation of search. Even if the user does not designate a place type or a place name but specifies a street name or other parameters (ex. city name, cross streets) in addition to the street name, he can find the intended POI quickly and easily.

### BRIEF DESCRIPTION OF THE DRAWINGS

FIGS. 1A-1H are schematic diagrams showing an example operational process and display example of navigation system for implementing the method and apparatus of the present invention.

FIGS. 2A-2C are schematic diagrams showing examples of displaying points of interest (POIs) icons displayed on a monitor screen of the navigation system in a manner superimposed on a map image.

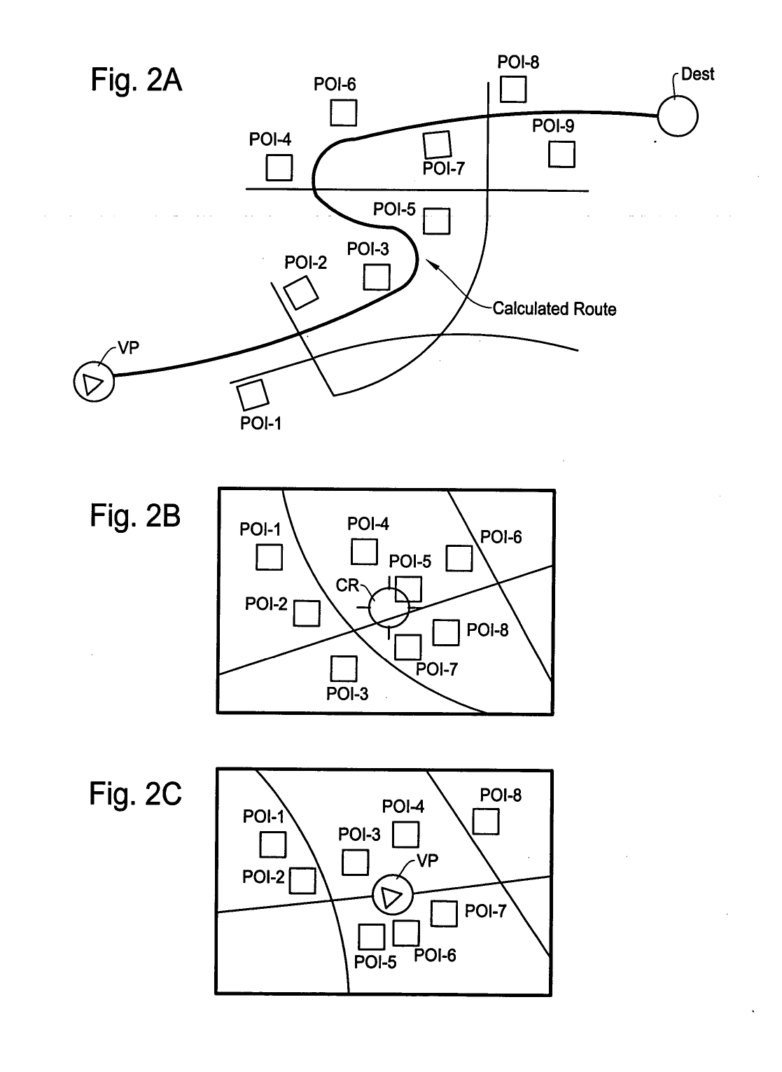

FIG. 3 is a block diagram showing an example of structure in a vehicle navigation system for implementing the POI search method of the present invention.

FIGS. 4A and 4B are diagrams showing an example of a remote controller accompanied by the vehicle navigation system of FIG. 3.

FIG. 5 is a flow chart showing an overall process of POI search method including a conventional POI search method and a new search method which is a search-by-street method of the present invention.

FIGS. 6A-6C are schematic diagrams showing basic concepts of three types of the search-by-street method in the present invention.

FIGS. 7A-7G are schematic diagrams showing examples of processes and display screens for implementing the three types of search-by-street method shown in FIGS. 6A-6C through the corresponding flows A-C in accordance with the present invention.

FIGS. 8A-8I are schematic diagrams showing an example of process and display screen involving the flow A of FIGS. 7A-7B for implementing the search-by-street method of the present invention.

FIGS. 9A-9G are schematic diagrams showing an example of process and display screen involving the flow B of FIGS. 7A-7D for implementing the search-by-street method of the present invention.

FIGS. 10A-10G are schematic diagrams showing an example of process and display screen involving the flow C of FIGS. 7A-7B and 7E-7G for implementing the search-by-street method of the present invention.

FIGS. 11A-11I are schematic diagrams showing another example of process and display screen involving the flow A of FIGS. 7A-7B for implementing the search-by-street method of the present invention.

FIGS. 12A-12I are schematic diagrams showing another example of process and display screen involving the flow B of FIGS. 7A-7D for implementing the search-by-street method of the present invention.

FIGS. 13A-13H are schematic diagrams showing another example of process and display screen involving the flow C of FIGS. 7A-7B and 7E-7G for implementing the search-by-street method of the present invention.

FIGS. 14A-14G are schematic diagrams showing a further example of process and display screen involving the flow B of FIGS. 7A-7D for implementing the search-by-street method of the present invention.

FIGS. 15A-15F are schematic diagrams showing a further example of process and display screen involving the flow C of FIGS. 7A-7B and 7E-7G for implementing the search-by-street method of the present invention.

### DETAILED DESCRIPTION OF THE INVENTION

The present invention will be described in detail with reference to the accompanying drawings. The navigation system of the present invention is designed to enable a user to easily and effectively find a desired point of interest (POI) and specify the POI as a destination through a search-by-street method. Typically, the search-by-street method of the present invention will be used during the conventional POI search process.

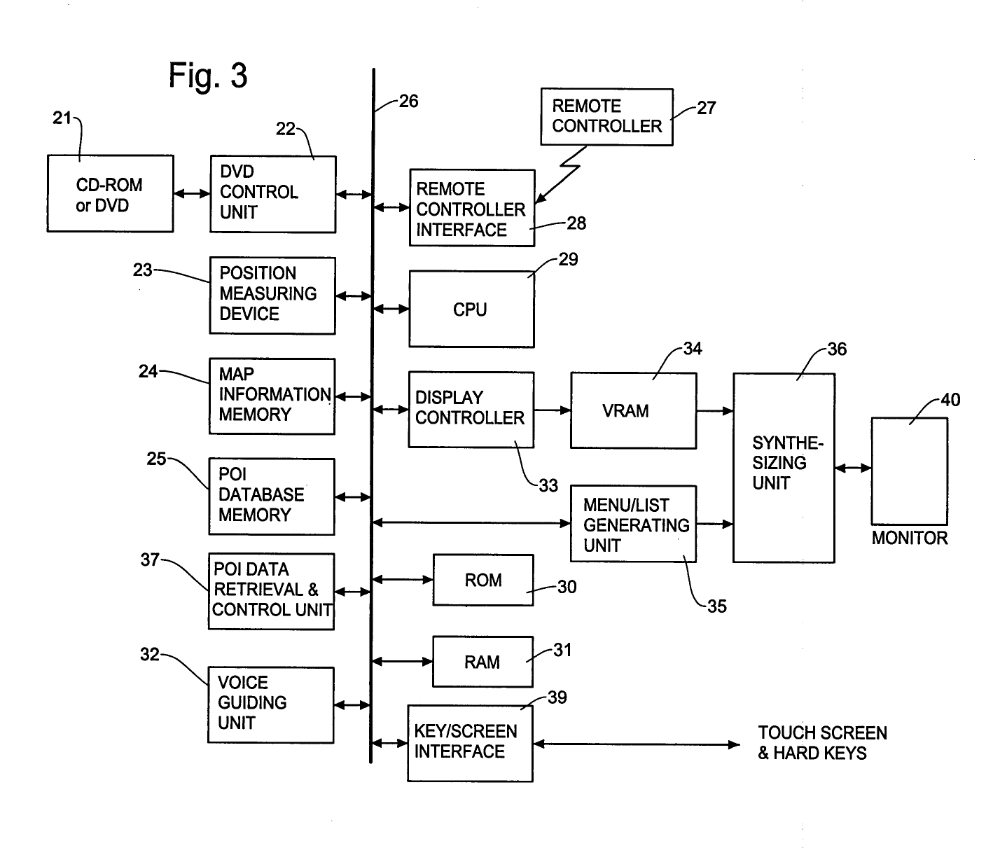

FIG. 3 shows an example of structure of a vehicle navigation system implementing the present invention. While the vehicle navigation system is explained for an illustration purpose, the present invention can also be applied to other types of navigation system. For example, the present invention can be advantageously used in a portable navigation device such as a one implemented in a PDA (personal digital assistant) device, a lap-top computer, or other hand-held devices.

In the block diagram of FIG. 3, the navigation system includes a map storage medium 21 such as a CD-ROM, DVD, hard disc or other storage means (hereafter “DVD”) for storing map information, a DVD control unit 22 for a controlling an operation for reading the map information from the DVD, a position measuring device 23 for measuring the present vehicle position. The position measuring device 23 includes a vehicle speed sensor for detecting a moving distance, a gyroscope for detecting a moving direction, a microprocessor for calculating a position, a GPS (Global Positioning System) receiver, and etc.

The block diagram of FIG. 3 further includes a map information memory 24 for storing the map information which is read out from the DVD 21, a database memory 25 for storing database information such as point of interest (POI) information which is read out from the DVD 21, a remote controller 27 for executing a menu selection operation, an enlarge/reduce operation, a destination input operation, etc. and a remote controller interface 28.

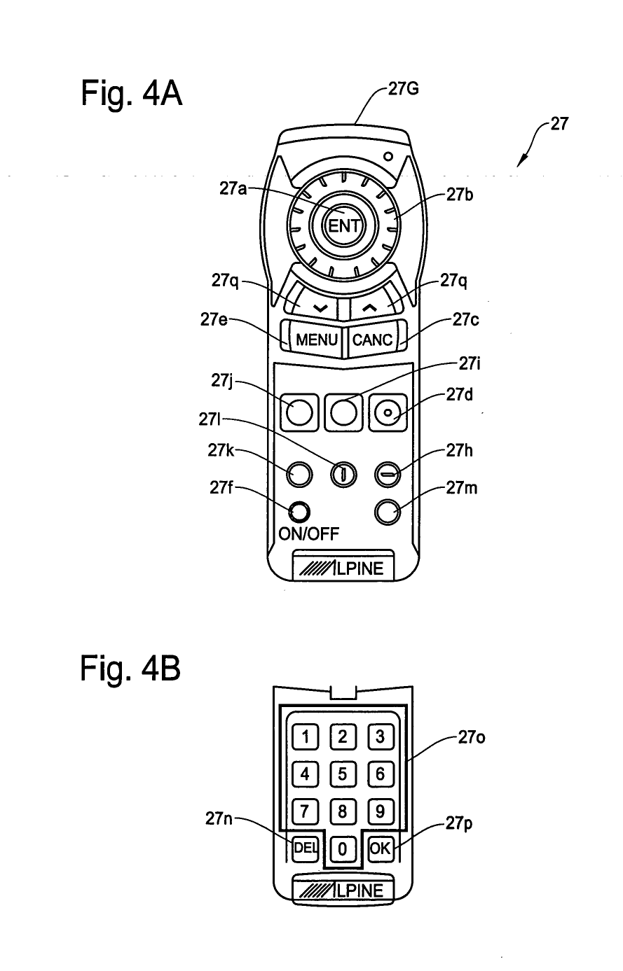

The remote controller 27 has a variety of function keys as shown in FIG. 4A and numeric keys as shown in FIG. 4B. The numeric keys appear when a lid in the lower part of FIG. 4A is opened. The remote controller 27 includes a joy stick/enter key 27a, a rotary encoder 27b, a cancel key 27c, an MP/RG key 27d, a menu key 27e, a zoom/scroll key 27q, a monitor ON/OFF key 27f, a remote control transmitter 27g, a plan key 27h, an N/H key 27i, a voice key 27j, a list key 27k, a detour key 271, a delete destination key 27m, a delete key 27n, numeric keys 27o, and an OK key 27p.

The joystick/enter key 27a selects highlighted items within the menu and moves map displays and a vehicle position icon. The rotary encoder 27b changes zoom scale, scrolls list pages, moves the cursor, and etc. The cancel key 27c cancels the present displayed screen or is operated when returning the screen to the previous menu screen. The MP/RG key 27d toggles between detailed map display and basic guide display during guidance. The menu key 27e displays the main menu. The plan key 27h starts the guidance to the route set by “Today's Plan” function, the N/H key 27i changes between north-up and heading-up orientation, the voice key 27j initiates voice instruction.

Although a remote controller such as described above is a typical example for selecting menus, executing selected functions and etc., the navigation system includes various other input methods to achieve the same and similar operations done through the remote controller. For example, the navigation system includes hard keys and a joystick on a head unit of the navigation system mounted on a dash board, touch screen of the display panel, and voice communication means.

Referring back to FIG. 3, the navigation system further includes a bus 26 for interfacing the above units in the system, a processor (CPU) 29 for controlling an overall operation of the navigation system, a ROM 30 for storing various control programs such as a route search program, a map matching program necessary for navigation control, and a POI display arrange program of the present invention, a RAM 31 for storing a processing result such as a guide route, a voice interface and guiding unit 32 for voice communication interface and spoken instructions, a display controller 33 for generating map image (a map guide image and an arrow guide image) on the basis of the map information, a VRAM (video RAM) 34 for storing images generated by the display controller, a menu/list generating unit 35 for generating menu images and various list images, a synthesizing unit 36, a monitor (display) 40 and a key and screen interface 39 for interfacing with various other input means such as hard keys and a joystick on a panel, and the like.

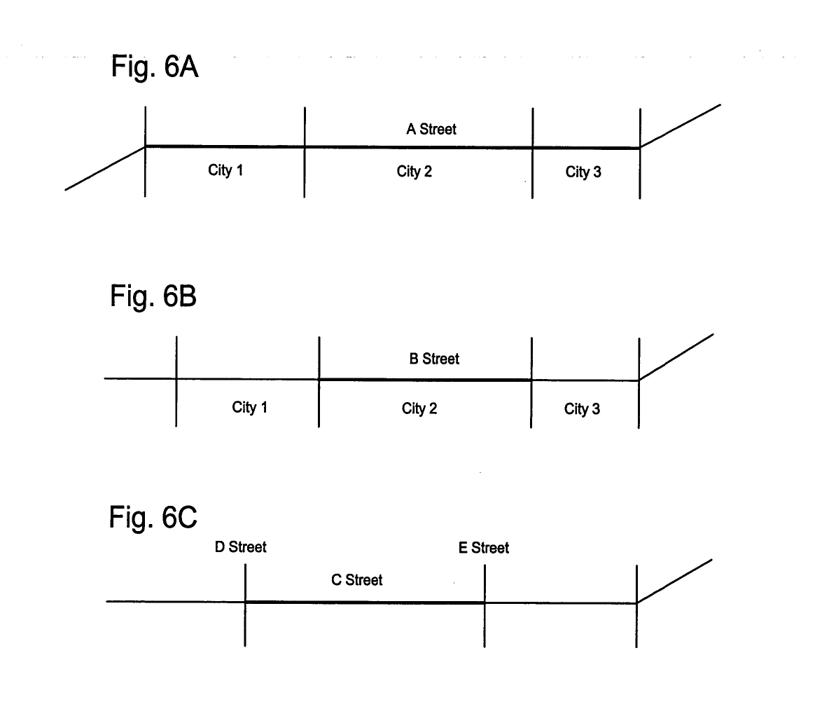

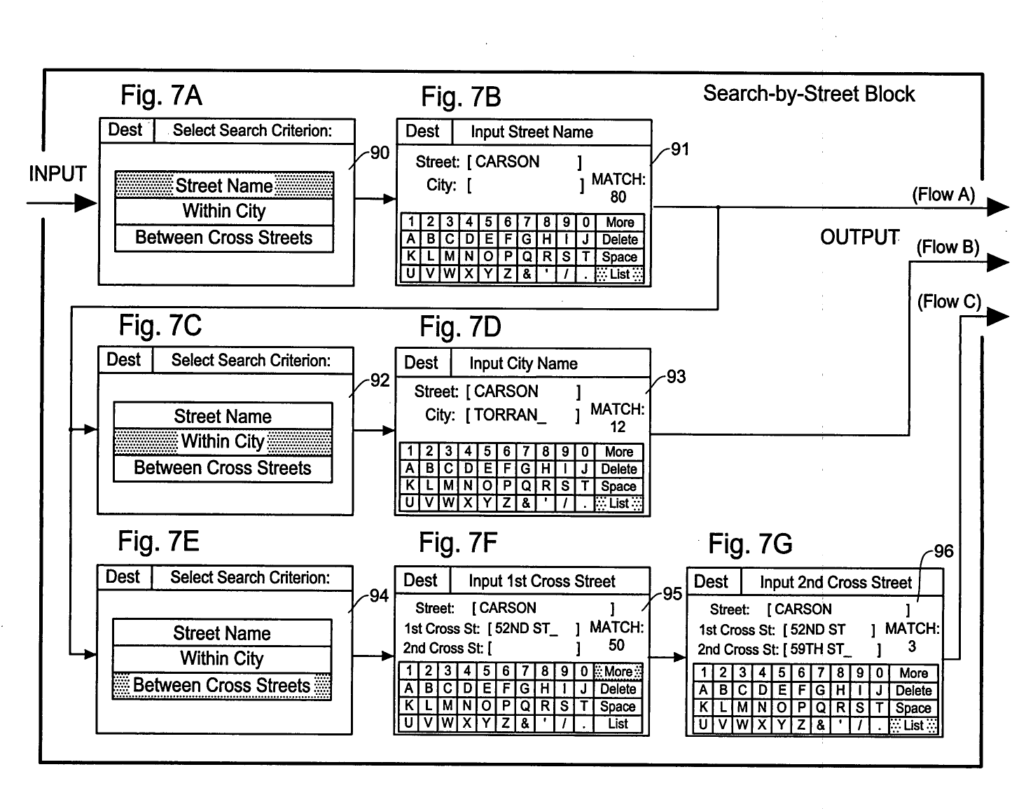

A POI data retrieval and control unit 37 is directed to the search-by-street method of the present invention. The POI data retrieval and control unit 37 has a function of controlling a POI retrieval process. Such a retrieval process is conducted for a specified range along a street specified by a user in the search-by-street process. The range of search in the search-by-street varies depending on a method selected by the user, such as along an entire street, along the street within a specified city, or along the street within two specified cross streets. The detailed description about this function is given below with reference to FIGS. 6A-6C and FIGS. 7A-7G.

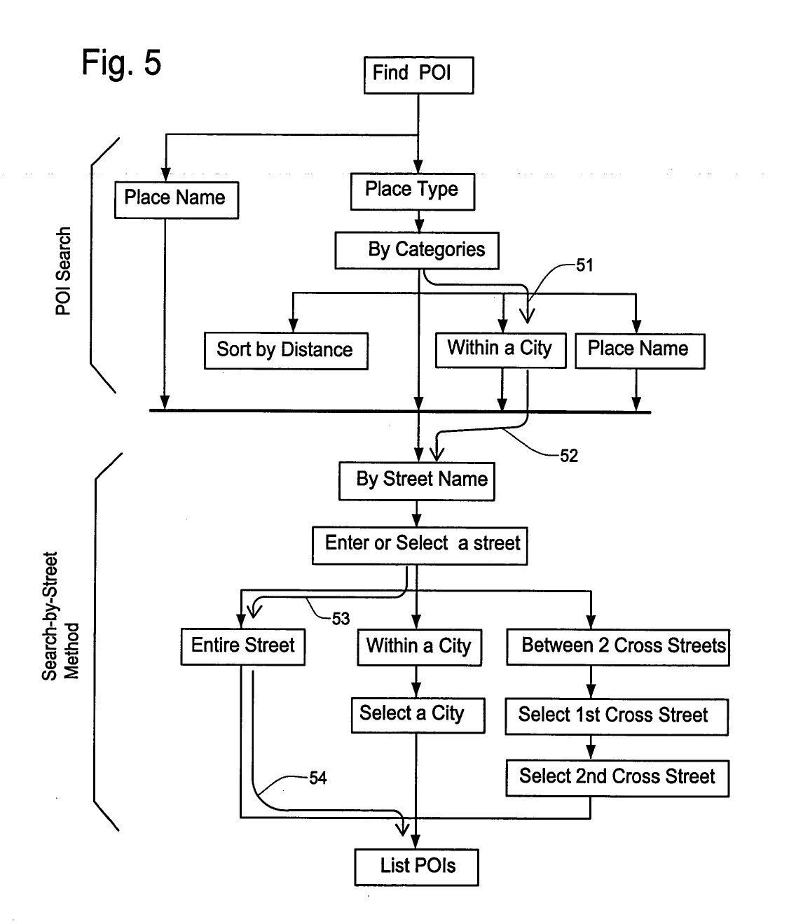

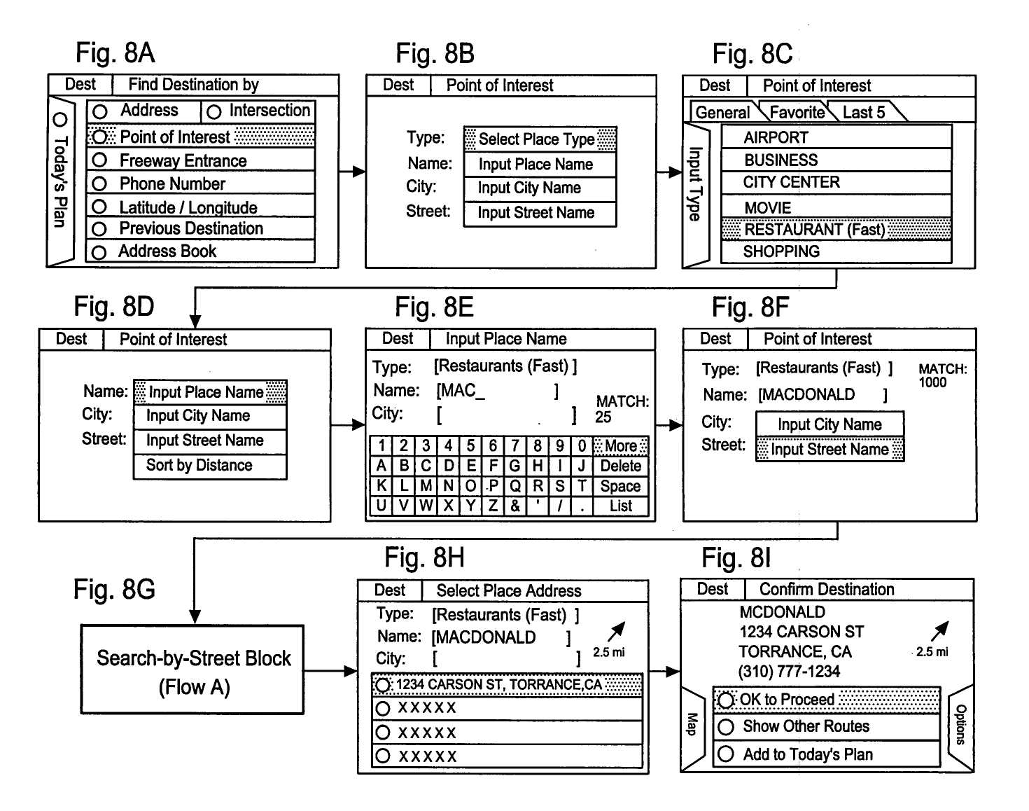

FIG. 5 shows how the search-by-street method is linked to a current POI search flow. The search-by-street method functions as a part of the existing POI search method. Although the search-by-street process is illustrate at the later stage of the POI search process, it can be used any time during the POI search process. Thus, the user can easily use the search-by-street method at an early stage, in a middle stage as well as a later stage of the search flow. For example, after a place name and a city name are defined, and the search based on these parameters have been performed, the user may search a preferred POI through the search-by-street method by specifying a street name as indicated by arrows 51-54. Alternatively, the user can use the search-by-street method at the start of the POI search process before defining a place type or a place name. Detailed processes and display examples involving the search-by-street method combined with the existing POI search process will be described later with reference to FIGS. 8-15.

The basic concept of the search-by-street method in the present invention is shown in FIGS. 6A-6C by using simple schematic diagrams. In this example, three search types in the search-by-street method are illustrated; (1) a search along an entire street, (2) a search along a street within a city, and (3) a search along a street between two cross streets. When the “entire street” search is selected, the navigation system retrieves and lists all POIs along the entire street specified by the user as shown by the solid line of FIG. 6A, i.e., throughout “A Street”. On the other hand, when the “street within a city” search is selected, the navigation system retrieves and lists only POIs along the specified street within the specified city as shown by the solid ling of FIG. 6B, i.e., “B Street” within “City 2”.

When the “street between two cross streets” search is selected, the navigation system retrieves and lists only POIs along the specified street within the specified two cross streets as shown by the solid ling of FIG. 6C, i.e., “C Street” between “E Street and D Street”. In this method, in addition to specifying the street (C Street), the user selects two names of cross streets (D Street and E Street). Although the user has to input three street names, he is usually able to find a desired POI (destination) easily and quickly. This is because, generally, this method is able to specify the search area to a limited range, and thus, the number of POIs listed is much smaller than that of the POIs listed by the “entire street” search or the “street within a city” search.

FIGS. 7A-7G show an example of operation process and screen display for implementing the search-by-street method of the present invention. FIGS. 7A-7B correspond to the “entire street” search of FIG. 6A, FIGS. 7A-7D correspond to the “street within a city” search of FIG. 6B, and FIGS. 7A-7B and 7E-7G correspond to the “street between two cross streets” search of FIG. 6C. In this example, the process of FIGS. 7A-7B is denoted by “flow A”, the process of FIGS. 7A-7D is denoted by “flow B”, and the process of FIS. 7A-7B and 7E-7G is denoted by “flow C”. One of the flows in the diagrams of FIGS. 7A-7G is used in the process of FIGS. 8-15 as a search-by-street block. Namely, this search-by-street block is linked to various points of current POI search flows such as shown in FIG. 5 and FIGS. 8-15, as will be described in detail later.

With reference to FIGS. 7A and 7B, the Flow A is directed to the “entire street” search. The user first selects a “Street Name” menu on a “Select Search Criterion” screen 90 of FIG. 7A. Then, the navigation system displays an “Input Street Name” screen 91 as shown in FIG. 7B. This screen illustrates a keyboard through which the user inputs a name of the street by using alphabetical and numerical keys and other function keys on the keyboard. In this example, a street name, “CARSON ST” is entered by the user. If the user selects a “List” key on the “input Street Name” screen 91, all POIs along the entire street will be displayed. In this case, the number of the POIs is “80” which is indicated as “MATCH: 80” on the screen 91.

The flow B involving FIGS. 7A-7D is directed to the “street within a city” search. After entering the street name in FIGS. 7A-7B, if the user wants to further specify a name of the city to narrow the area of the search, he can select a “More” key on the keyboard image to enter into the flow B or flow C. Then, the navigation system displays a “Select Search Criterion” screen 92 or 94 as shown in FIG. 7C or 7E. If the user selects a “Within City” menu in FIG. 7C, the navigation system displays an “Input City Name” screen 93 as shown in FIG. 7D which is again the keyboard screen. Through the keyboard, the user enters a city name, “Torrance” in this example. Then, when the user selects the “List” key, the navigation system retrieves POIs along “Carson Street” within the city of “Torrance” which will be listed on the next screen.

The flow C involving FIGS. 7A-7B and 7E-7G is directed to the “street between two cross streets”. After entering the street name on the “Input street Name” screen 91 of FIG. 7B, the user may want to limit the search range within a specific range between two intersections. In such a case, the user hits the “More” key in FIG. 7B to move to a “Select Search Criterion” screen 94 of shown in FIG. 7E where he selects a “Between Cross Streets” menu.

The user enters a name of the first cross street, for example, “52nd ST” on an “Input first Cross St” screen 95 such as shown in FIG. 7F. Then, the user enters a name of the second cross street “59th ST”, for example, on an “Input Second Cross St” screen 96 as shown in FIG. 7G. If the user selects the “List” key on the keyboard, all the POIs along Carson Street between the 52nd Street and 59th Street will be displayed. In this example, the number of the POIs is 3 as illustrated by “MATCH: 3”. In this process, since the range of search is significantly limited, the user can find out the preferred POI easily and accurately.

FIGS. 8-15 show examples of processes and display screens in the present invention where the search-by-street method of the present invention is implemented during the POI search method in the navigation system. One of the Flows A, B and C is integrated in the POI search flows in these examples as a search-by-street block. It should be noted that the examples shown here do not represent all the cases in actual POI search flows. Rather, these examples are typical operational flows in the POI search method described here for an illustration purpose. In the examples of FIGS. 8-15, it is assumed a case where the user wants to find and go to a fast food restaurant “Macdonald” on Carson Street in a city of Torrance.

FIGS. 8A-8I show an example of process and display screen involving the flow A of the search-by-street method for searching “Macdonald” on Carson Street of Torrance. This example shows the case where the user specifies a place type, a place name, and then, a street name during the search process. When selecting the street name menu, the navigation system moves to the search-by-street process described in FIGS. 6A-6C and 7A-7G. In this example, the flow A in the search-by-street process of FIG. 7 is used for searching the POI along the entire length of the specified street.

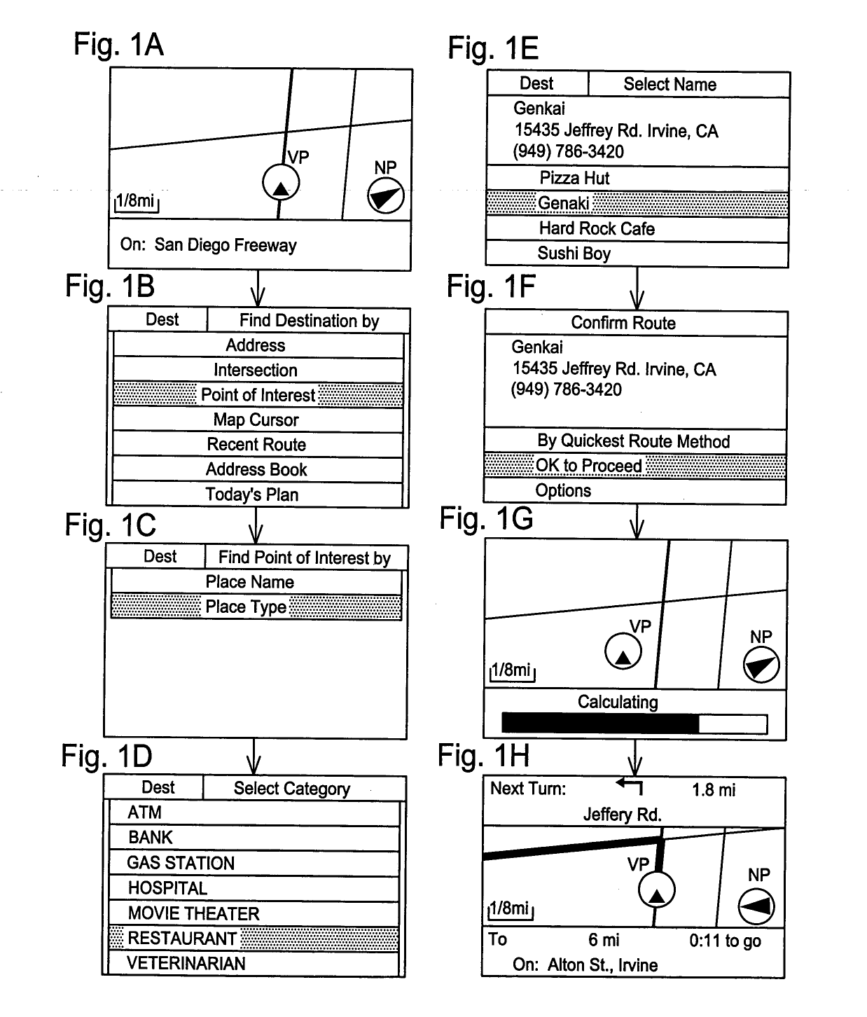

As a first step, the user chooses a “Point of Interest” menu on a “Find Destination by” screen of FIG. 8A which is equivalent to the screen of FIG. 1B described above. The navigation system displays a “Point of Interest” screen as shown in FIG. 8B which lists “Select Place Type”, “Input Place Name”, “Input City Name” and “Input Street Name”. In this example, the user chooses the “Select Place Type” menu to select a type of POI, i.e., a category of “Macdonald”.

Thus, the navigation system displays another “Point of Interest” screen which lists types (categories and sub-categories) of POIs as shown in FIG. 8C, on which the user selects a type “Restaurants (Fast)” in this case. Then, the navigation system displays a “Point of Interest” such as shown in FIG. 8D which lists “Input Place Name”, “Input City Name”, “Input Street Name”, and “Sort by Distance”. If the “Sort by Distance” is selected, the navigation system lists the POIs in the selected type “Restaurants (Fast)” in the order of distance from the current user position.

In FIG. 8D, the user selects the “Input Place Name” menu, and the navigation system displays an “Input Place Name” screen as shown in FIG. 8E. The user inputs the name “Macdonald” by using the keyboard on the screen. Since the search process starts as soon as the first character or number is entered, it may not be necessary to input all the characters of the place name. If the “List” key is selected, the navigation system displays the “Point of Interest” screen again which illustrates the information acquired up to the present and prompts the user to select either “Input City Name” or “Input Street Name” as shown in FIG. 8F.

By selecting the “Input Street Name”, the process moves to the search-by-street block (flow A) of FIG. 8G which conducts the search-by-street method of the present invention. The flow A is performed in the manner shown in FIGS. 7A and 7B as noted above. The user selects the “Input Street Name” menu in FIG. 7A and inputs the street name through the keyboard screen of FIG. 7B. In this example, since the user inputs the name of the street “CARSON” as shown in FIG. 7B and selects the “List” key, the search range is an entire street of “Carson Street” even if the street extends to other cities or states.

Then, the navigation system displays a “Select Place Address” screen as shown in FIG. 8H in which all “Macdonald” restaurants along the entire Carson Street are listed. The user selects one of the addresses on the screen where he wants to go. Then, the navigation system displays a “Confirm Destination” screen as shown in FIG. 8I to confirm the final destination. When the “OK to Proceed” menu is selected, the navigation system calculates the route to the destination and proceeds to the route guidance such as shown in FIG. 1H.

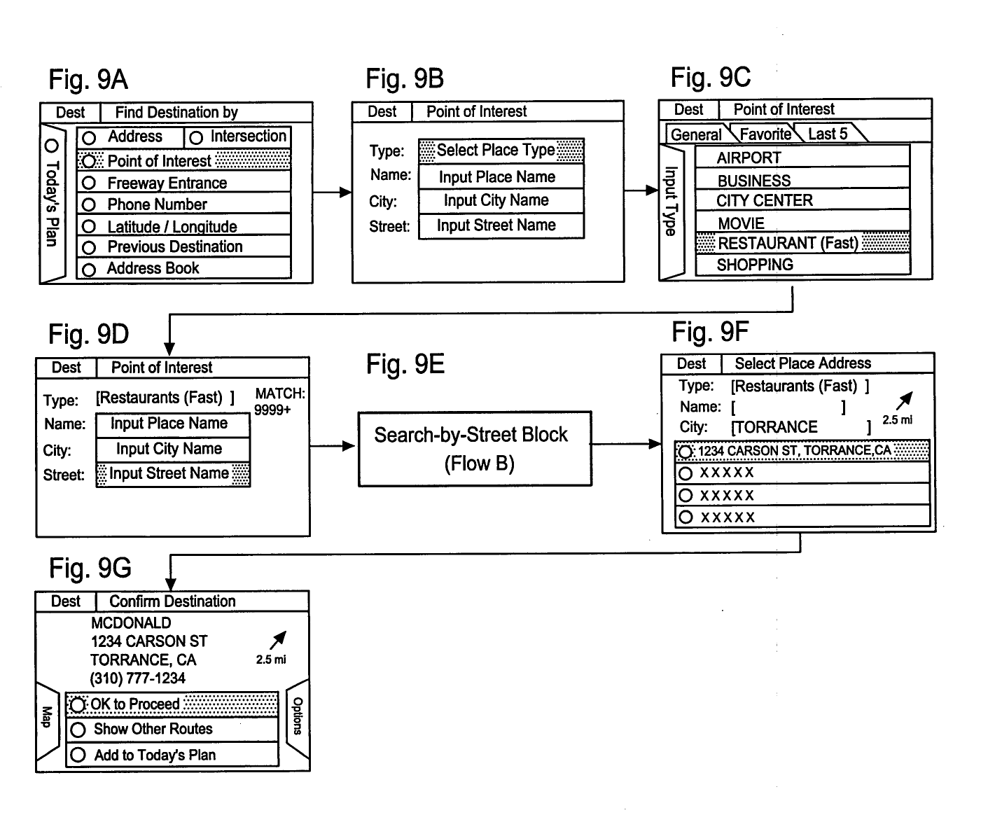

FIGS. 9A-9G show the next example which involves the flow B of the search-by-street method of the present invention. This example shows the case where the user specifies a place type, and then, a street name during the search process. When selecting the street name menu, the navigation system moves to the search-by-street process described in FIGS. 6A-6C and 7A-7G. In this example, the flow B in the search-by-street process of FIG. 7 is used for searching the POI along the specified street only within the city specified by the user.

As a first step, the user chooses a “Point of Interest” menu on a “Find Destination by” screen of FIG. 9A. The navigation system displays a “Point of Interest” screen as shown in FIG. 9B which lists “Select Place Type”, “Input Place Name”, “Input City Name” and “Input Street Name”. In this example, the user chooses the “Select Place Type” menu to select a type of POI where “Macdonald” belongs.

Thus, the navigation system displays another “Point of Interest” screen which lists types (categories and sub-categories) of POIs as shown in FIG. 9C, on which the user selects a type “Restaurants (Fast)” in this case. Then, the navigation system displays a “Point of Interest” such as shown in FIG. 9D which lists “Input Place Name”, “Input City Name”, “Input Street Name” to prompt the user to select one of them. In FIG. 9D, the place type “Restaurant (Fast)” is shown on the screen since it is already specified in the process of FIG. 9C.

In FIG. 9D, the user selects the “Input Street Name” menu, and the navigation system moves to the search-by-street process (flow B) in FIG. 9E. The flow B is performed in the manner shown in FIGS. 7A-7D as noted above. The user selects the “Input Street Name” menu in FIG. 7A and inputs the street name through the keyboard screen of FIG. 7B. In this example, the user inputs the name of the street “CARSON” as shown in FIG. 7B and selects the “More” key. Thus, the process moves to the “Select Search Criterion” screen 92 of FIG. 7C on which the user selects the “Within City” menu.

Accordingly, the navigation system displays the keyboard screen of FIG. 7D through which the user inputs the city name “TORRANCE”. Thus, both the street name “Carson Street” and the city name “Torrance” are specified in the foregoing process. The user hits the “List” key, and the navigation system lists all the first food restaurants along the “Carson Street” within the city of “Torrance” as shown in FIG. 9F. Since the name of the restaurant is not defined, the list includes all of the first food restaurants where the user selects “Macdonald” from the list. Then, the navigation system displays a “Confirm Destination” screen as shown in FIG. 9G to confirm the final destination. When the “OK to Proceed” menu is selected, the navigation system calculates the route to the destination for route guidance.

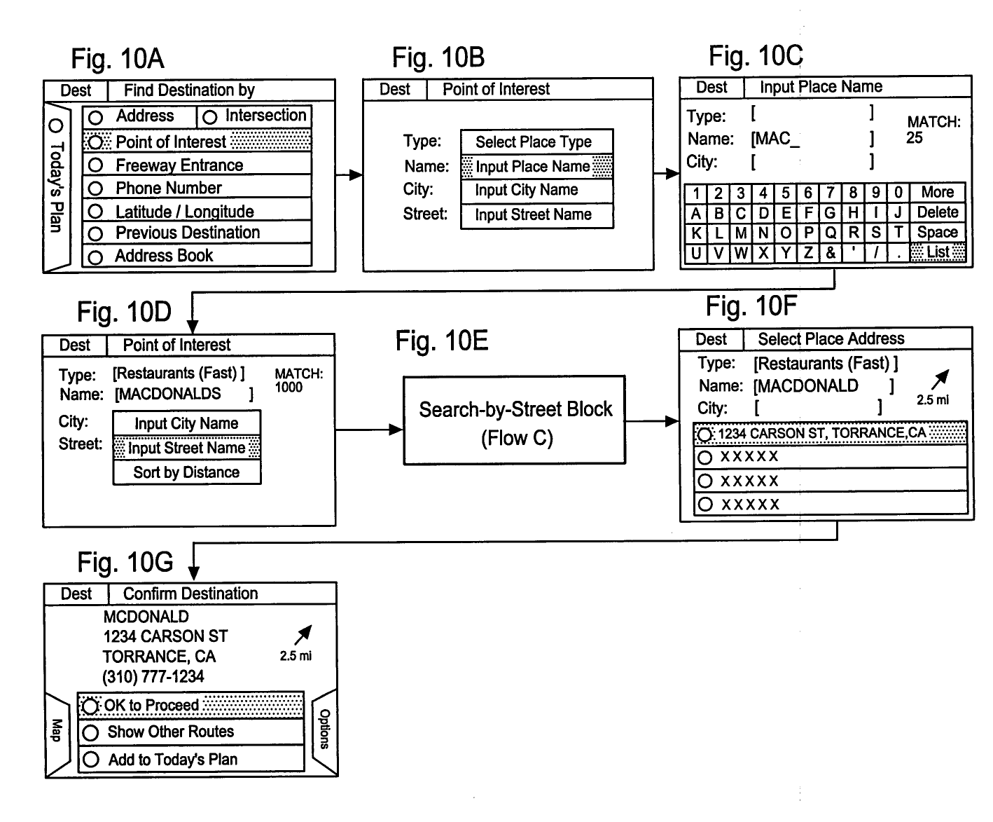

FIGS. 10A-10G show the next example which involves the flow C of the search-by-street method of the present invention. This example shows the case where the user specifies a place name, and then, a street name during the search process. When selecting the street name menu, the navigation system moves to the search-by-street process described in FIGS. 6A-6C and 7A-7G. In this example, the flow C in the search-by-street process of FIG. 7 is used for searching the POI along the specified street only within two cross streets specified by the user.

As a first step, the user chooses a “Point of Interest” menu on a “Find Destination by” screen of FIG. 10A. The navigation system displays a “Point of Interest” screen as shown in FIG. 10B which lists “Select Place Type”, “Input Place Name”, “Input City Name” and “Input Street Name”. In this example, the user chooses the “Input Place Name” menu to input the name of the first food restaurant “Macdonald”.

Thus, the navigation system displays an “Input Place Name” screen including a keyboard image as shown in FIG. 10C. The user inputs the name “MACDONALD” by using the keyboard on the screen. Since the search process starts as soon as the first character or number is entered, it may not be necessary to input all the characters of the place name. If the “List” key is selected, the navigation system displays the “Point of Interest” screen again which illustrates the information acquired up to the present and prompts the user to select either “Input City Name” or “Input Street Name” as shown in FIG. 10D. In FIG. 10D, the place name “Macdonald” and the place type “Restaurant (Fast)” are shown on the screen since the place name (and thus the place type) is already specified in the process of FIG. 10C.

In FIG. 10D, the user selects the “Input Street Name” menu, and the navigation system moves to the search-by-street process (flow C) in FIG. 10E. The flow C is performed in the manner shown in FIGS. 7A-7B and 7E-7G as noted above. The user selects the “Input Street Name” menu in FIG. 7A and inputs the street name through the keyboard screen of FIG. 7B. In this example, the user inputs the name of the street “CARSON” as shown in FIG. 7B and selects the “More” key. Thus, the process moves to the “Select Search Criterion” screen of FIG. 7E on which the user selects the “Between Cross Streets” menu.

Accordingly, the navigation system displays the keyboard screen of FIG. 7F through which the user inputs the name of the first cross street “52nd Street” and presses the “More” key. Then, the navigation system displays the key board screen of FIG. 7G through which the user inputs the name of the second cross street “59th Street”. Thus, the street name “Carson Street” and the two intersections on the street are specified in the foregoing process.

Thus, when the user hits the “List” key, the navigation system lists all the “Macdonald” restaurants along the “Carson Street” between the “52nd Street” and the “59th Street” as shown in FIG. 10F. Since the name of the restaurant is already defined, the list includes only “Macdonald” restaurants on the “Carson Street” between the two intersections “52nd Street” and “59th Street”. Then, the navigation system displays a “Confirm Destination” screen as shown in FIG. 10G to confirm the final destination. When the “OK to Proceed” menu is selected, the navigation system calculates the route to the destination and moves to the route guidance mode.

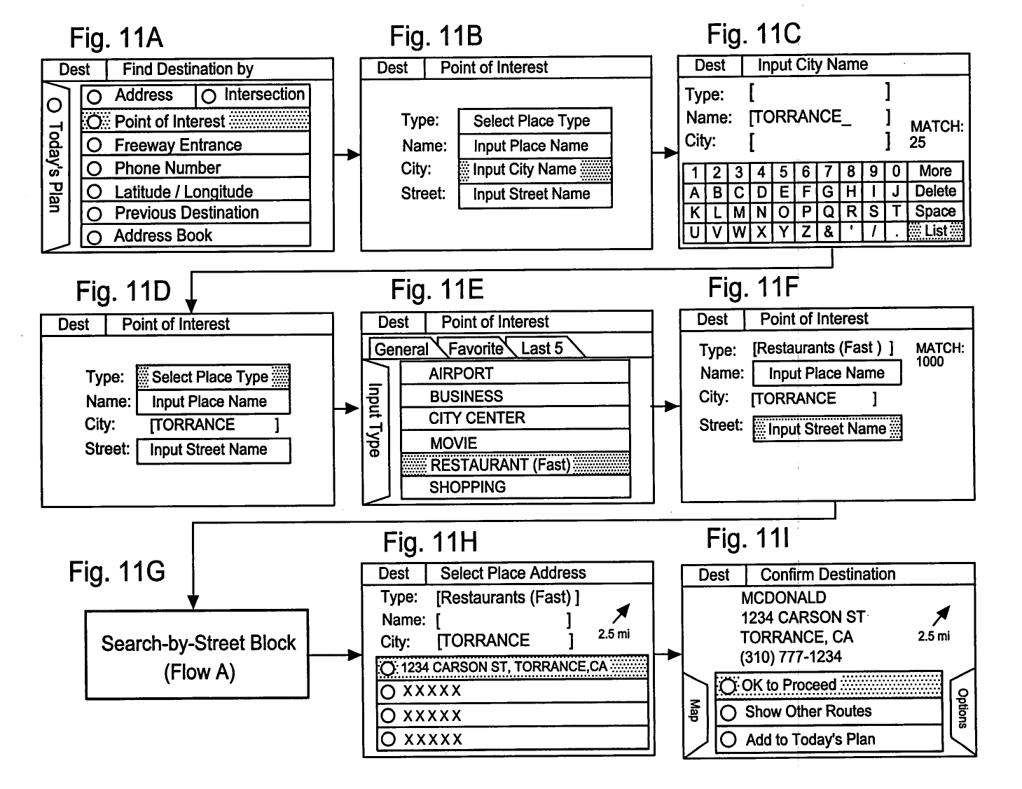

FIGS. 11A-11I show an example of process and display screen involving the flow A of the search-by-street method for searching “Macdonald” on Carson Street of Torrance. This example shows the case where the user specifies a city name, a place type, and then, a street name during the search process. When selecting the street name menu, the navigation system moves to the search-by-street process described in FIGS. 6A-6C and 7A-7G. In this example, the flow A in the search-by-street process of FIG. 7 is used for searching the POI along the entire length of the specified street.

As a first step, the user chooses a “Point of Interest” menu on a “Find Destination by” screen of FIG. 11A. The navigation system displays a “Point of Interest” screen as shown in FIG. 11B which lists “Select Place Type”, “Input Place Name”, “Input City Name” and “Input Street Name”. In this example, the user chooses the “Input City Name” menu to input a city name “Torrance”.

Thus, the navigation system displays an “Input City Name” screen which includes a keyboard image as shown in FIG. 11C. Here, the user types-in the city name “Torrance” through the keyboard and hits the “List” key. Then, the navigation system displays a “Point of Interest” screen such as shown in FIG. 11D which lists “Select Place Type”, “Input Place Name” and “Input Street Name” to prompt the user to select one of them. Since the city name is already defined, the screen of FIG. 11D shows the city name “TORRANCE”.

When the user selects the “Select Place Type” menu in FIG. 11D, the navigation system displays the “Point of Interest” screen as shown in FIG. 11E. The screen of FIG. 11E lists types (categories and sub-categories) of POIs, on which the user selects a type “Restaurants (Fast)” in this case. Then, the navigation system displays a “Point of Interest” such as shown in FIG. 11F which prompts the user to select “Input Place Name” or “Input Street Name”. Since the city name and the POI type are already defined, the screen of FIG. 11F shows the city name “TORRANCE” and the POI type “RESTAURANT (Fast)”.

By selecting the “Input Street Name”, the process moves to the search-by-street block (flow A) of FIG. 11G which conducts the search-by-street method of the present invention. The flow A is performed in the manner shown in FIGS. 7A and 7B as noted above. The user selects the “Input Street Name” menu in FIG. 7A and inputs the street name through the keyboard screen of FIG. 7B. In this example, the user inputs the name of the street “CARSON” as shown in FIG. 7B and selects the “List” key. Ordinarily, the search range is an entire street of “Carson Street”, however, since the city name is already specified in the process of FIG. 11C, the navigation system retrieves the POIs (fast food restaurant) along the “Carson Street” within the city “Torrance”. In other words, in this particular case, the search method is practically the same as that of the flow B even though the flow A is used.

Then, the navigation system displays a “Select Place Address” screen as shown in FIG. 11H in which all fast food restaurants including “Macdonald” on “Carson Street” within “Torrance” are listed. The user selects his favorite “Macdonald” from the addresses on the screen where he wants to go. Then, the navigation system displays a “Confirm Destination” screen as shown in FIG. 11I to confirm the final destination. When the “OK to Proceed” menu is selected, the navigation system calculates the route to the destination and moves to the route guidance mode.

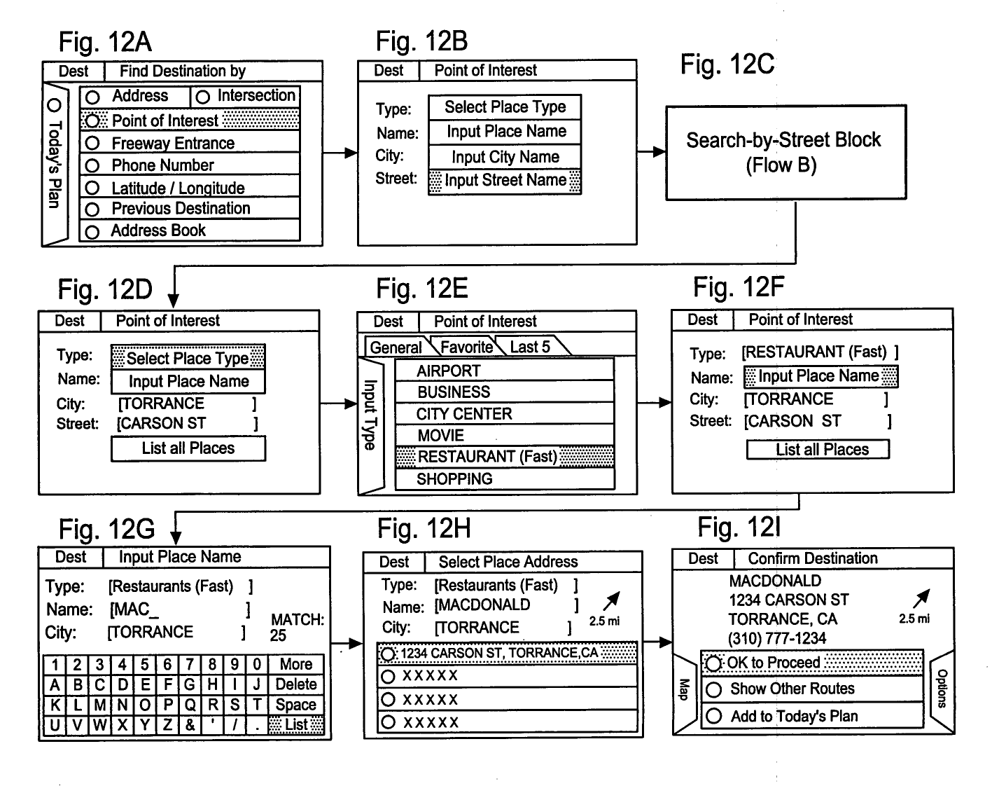

FIGS. 12A-12I show an example of process and display screen involving the flow B of the search-by-street method for searching “Macdonald” on Carson Street of Torrance. This example shows the case where the user specifies, first, a street name and a city name, and then, a place type and a place name during the search process. When selecting the street name menu, the navigation system moves to the search-by-street process described in FIGS. 6A-6C and 7A-7G. In this example, the flow B in the search-by-street process of FIG. 7 is used for searching the POI along the specified street within the specified city.

As a first step, the user chooses a “Point of Interest” menu on a “Find Destination by” screen of FIG. 12A. The navigation system displays a “Point of Interest” screen as shown in FIG. 12B which lists “Select Place Type”, “Input Place Name”, “Input City Name” and “Input Street Name”. In this example, the user chooses the “Input Street Name” menu to use the search-by-street method. Accordingly, the navigation system moves to the search-by-street process (flow B) in FIG. 12C.

The flow B is per-formed in the manner shown in FIGS. 7A-7D as noted above. The user selects the “Input Street Name” menu in FIG. 7A and inputs the street name through the keyboard screen of FIG. 7B. In this example, the user inputs the name of the street “CARSON” as shown in FIG. 7B and selects the “More” key. Thus, the process moves to the “Select Search Criterion” screen of FIG. 7C on which the user selects the “Within City” menu. Accordingly, the navigation system displays the keyboard screen of FIG. 7D through which the user inputs the city name “TORRANCE”.

Thus, both the street name “Carson Street” and the city name “Torrance” are specified in the foregoing process. Since the place type of place name is not specified, when the user hits the “List” key, the navigation system displays the “Point of Interest” screen of FIG. 12D which lists “Select Place Type”, “Input Place Name” and “List All Places” to prompt the user to select one of them. Since the street name and the city name are already defined in the flow B above, the screen of FIG. 12D shows the city name “TORRANCE” and street name “CARSON ST”.

When the user selects the “Select Place Type” menu in FIG. 12D, the navigation system displays the “Point of Interest” screen as shown in FIG. 12E. The screen of FIG. 12E lists types (categories and sub-categories) of POIs, on which the user selects a type “Restaurants (Fast)” in this case. Then, the navigation system displays a “Point of Interest” such as shown in FIG. 12F which prompts the user to select “Input Place Name” or “List All Places”. The screen of FIG. 12F shows the place type “RESTAURANT”, city name “TORRANCE” and street name “CARSON ST” since these items are already defined in the above process.

In this example, the user chooses the “Input Place Name” menu to input the name of the first food restaurant “Macdonald”. Thus, the navigation system displays an “Input Place Name” screen which includes a keyboard image as shown in FIG. 12G. The user inputs the name “MACDONALD” by using the keyboard on the screen. Since the search process starts as soon as the first character or number is entered, it may not be necessary to input all the characters of the place name. If the “List” key is selected, the navigation system displays the restaurant “Macdonald” on the “Carson Street” within the city of “Torrance” as shown in FIG. 12H. Then, the navigation system displays a “Confirm Destination” screen as shown in FIG. 12I to confirm the final destination. When the “OK to Proceed” menu is selected, the navigation system calculates the route to the destination and moves to the route guidance mode.

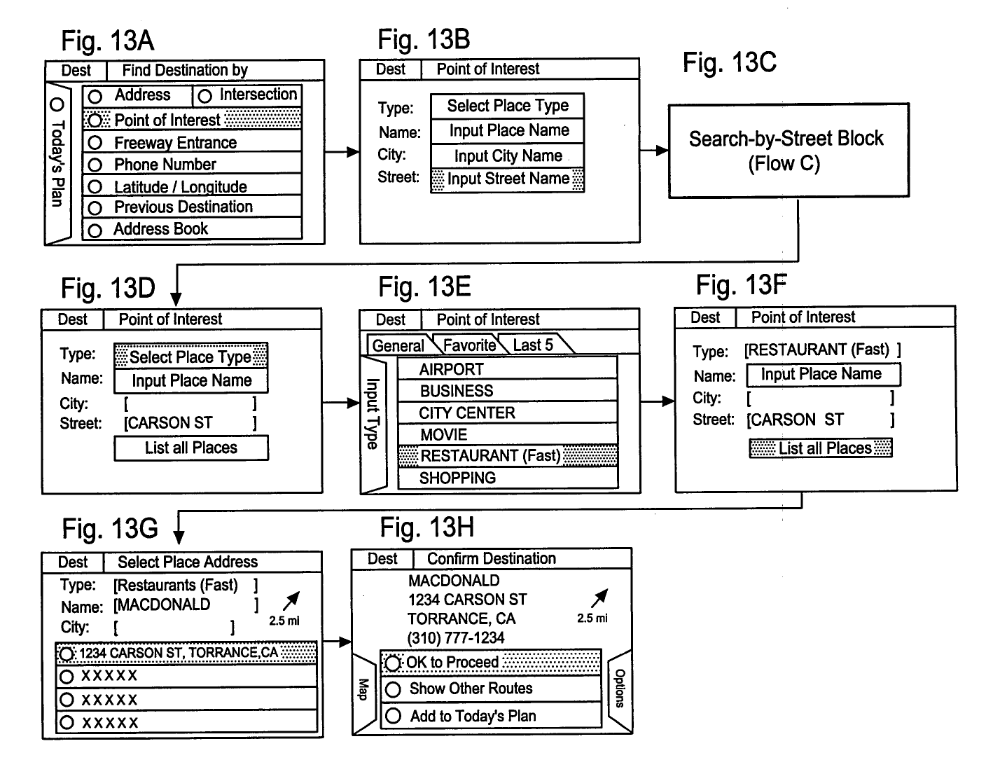

FIGS. 13A-13H show an example of process and display screen involving the flow C of the search-by-street method for searching “Macdonald” on Carson Street of Torrance. This example shows the case where the user specifies a street name between two intersections first, and then, a place type and a place name during the search process. When selecting the street name menu, the navigation system moves to the search-by-street process described in FIGS. 6A-6C and 7A-7G. In this example, the flow C in the search-by-street process of FIG. 7 is used for searching the POI along the specified street between the two cross streets.

As a first step, the user chooses a “Point of Interest” menu on a “Find Destination by” screen of FIG. 13A. The navigation system displays a “Point of Interest” screen as shown in FIG. 13B which lists “Select Place Type”, “Input Place Name”, “Input City Name” and “Input Street Name”. In this example, the user chooses the “Input Street Name” menu to use the search-by-street method. Accordingly, the navigation system moves to the search-by-street process (flow C) in FIG. 13C.

The flow C is performed in the manner shown in FIGS. 7A-7B and 7E-7G as noted above. First, the user selects the “Input Street Name” menu in FIG. 7A and inputs the street name through the keyboard screen of FIG. 7B. In this example, the user inputs the name of the street “CARSON” as shown in FIG. 7B and selects the “More” key. Thus, the process moves to the “Select Search Criterion” screen of FIG. 7E through which the user selects the “Between Cross Streets” menu.

Accordingly, the navigation system displays the keyboard screen of FIG. 7F through which the user inputs the name of the first cross street “52nd Street” and presses the “More” key. Then, the navigation system displays the key board screen of FIG. 7G through which the user inputs the name of the second cross street “59th Street”. Thus, the street name “Carson Street” and the two intersections on the street are specified in the foregoing process.

Since the place type of place name is not specified, when the user hits the “List” key, the navigation system displays the “Point of Interest” screen of FIG. 13D which lists “Select Place Type”, “Input Place Name” and “List All Places” to prompt the user to select one of them. Since the street name and two cross streets are already defined in the flow C above, the screen of FIG. 13D shows the street name “CARSON ST” although the two cross streets are not shown in this example.

When the user selects the “Select Place Type” menu in FIG. 13D, the navigation system displays the “Point of Interest” screen as shown in FIG. 13E. The screen of FIG. 13E lists types (categories and sub-categories) of POIs, on which the user selects a type “Restaurants (Fast)” in this case. Then, the navigation system displays a “Point of Interest” such as shown in FIG. 13F which prompts the user to select “Input Place Name” or “List All Places”. The screen of FIG. 13F shows the place type “RESTAURANT” and street name “CARSON ST” since these items are already defined in the above process.

In this example, the user chooses the “List all Places” menu to list all of the fast food restaurant on “Carson Street” between the 52nd street and 59th street as shown in FIG. 13G. The user selects his favorite restaurant “Macdonald” on “Carson Street” within the 52nd street and 59th street as shown in FIG. 13H. Then, the navigation system displays a “Confirm Destination” screen as shown in FIG. 13I to confirm the final destination. When the “OK to Proceed” menu is selected, the navigation system calculates the route to the destination and moves to the route guidance mode.

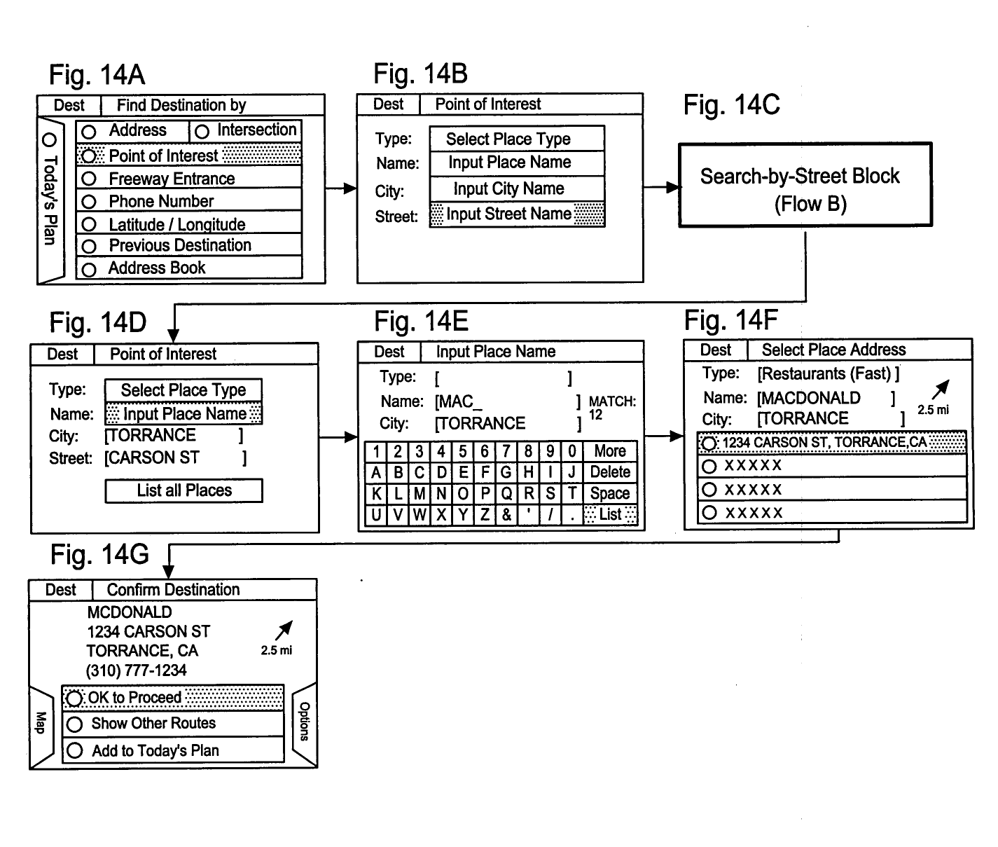

FIGS. 14A-14G show an example of process and display screen involving the flow B of the search-by-street method for searching “Macdonald” on Carson Street of Torrance. This example shows the case where the user specifies a street name and a city name first, and then, a place name during the search process. When selecting the street name menu, the navigation system moves to the search-by-street process described in FIGS. 6A-6C and 7A-7G. In this example, the flow B in the search-by-street process of FIG. 7 is used for searching the POI along the specified street within the specified city.

As a first step, the user chooses a “Point of Interest” menu on a “Find Destination by” screen of FIG. 14A. The navigation system displays a “Point of Interest” screen as shown in FIG. 14B which lists “Select Place Type”, “Input Place Name”, “Input City Name” and “Input Street Name”. In this example, the user chooses the “Input Street Name” menu to use the search-by-street method. Accordingly, the navigation system moves to the search-by-street process (flow B) in FIG. 14C.

The flow B is performed in the manner shown in FIGS. 7A-7D as noted above. The user selects the “Input Street Name” menu in FIG. 7A and inputs the street name through the keyboard screen of FIG. 7B. In this example, the user inputs the name of the street “CARSON” as shown in FIG. 7B and selects the “More” key. Thus, the process moves to the “Select Search Criterion” screen of FIG. 7C on which the user selects the “Within City” menu. Accordingly, the navigation system displays the keyboard screen of FIG. 7D through which the user inputs the city name “TORRANCE”.

Thus, both the street name “Carson Street” and the city name “Torrance” are specified in the foregoing process. Since the place type of place name is not specified, when the user hits the “List” key, the navigation system displays the “Point of Interest” screen of FIG. 14D which lists “Select Place Type”, “Input Place Name” and “List All Places” to prompt the user to select one of them. Since the street name and the city name are already defined in the flow B above, the screen of FIG. 14D shows the city name “TORRANCE” and street name “CARSON ST”.

When the user selects the “Input Place Name” menu in FIG. 14D, the navigation system displays the “Input Place Name” screen as shown in FIG. 14E which includes a keyboard. The user inputs the name “MACDONALD” by using the keyboard on the screen. Since the search process starts as soon as the first character or number is entered, it may not be necessary to input all the characters of the place name. If the “List” key is selected, the navigation system displays the restaurant “Macdonald” on the “Carson Street” within the city of “Torrance” as shown in FIG. 14F. Then, the navigation system displays a “Confirm Destination” screen as shown in FIG. 14G to confirm the final destination. When the “OK to Proceed” menu is selected, the navigation system calculates the route to the destination and moves to the route guidance mode.

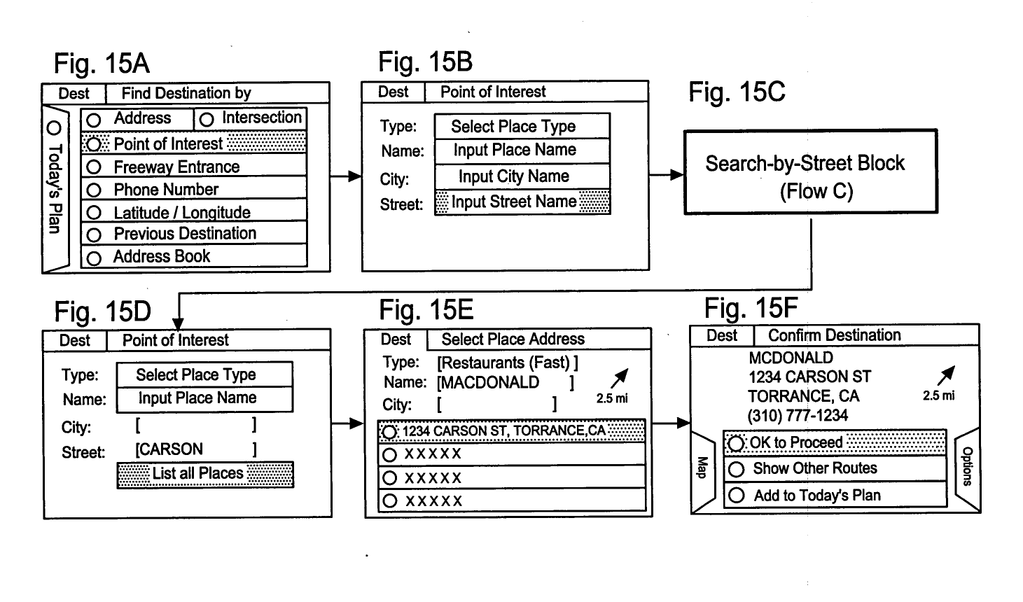

FIGS. 15A-15F show an example of process and display screen involving the flow C of the search-by-street method for searching “Macdonald” on Carson Street of Torrance. This example shows the case where the user specifies only a street name between two intersections during the search process. When selecting the street name menu, the navigation system moves to the search-by-street process described in FIGS. 6A-6C and 7A-7G. In this example, the flow C in the search-by-street process of FIG. 7 is used for searching the POI along the specified street between the two intersections.

As a first step, the user chooses a “Point of Interest” menu on a “Find Destination by” screen of FIG. 15A. The navigation system displays a “Point of Interest” screen as shown in FIG. 15B which lists “Select Place Type”, “Input Place Name”, “Input City Name” and “Input Street Name”. In this example, the user chooses the “Input Street Name” menu to use the search-by-street method. Accordingly, the navigation system moves to the search-by-street process (flow C) in FIG. 15C.

The flow C is performed in the manner shown in FIGS. 7A-7B and 7E-7G as noted above. First, the user selects the “Input Street Name” menu in FIG. 7A and inputs the street name through the keyboard screen of FIG. 7B. In this example, the user inputs the name of the street “CARSON” as shown in FIG. 7B and selects the “More” key. Thus, the process moves to the “Select Search Criterion” screen of FIG. 7E through which the user selects the “Between Cross Streets” menu.

Accordingly, the navigation system displays the keyboard screen of FIG. 7F through which the user inputs the name of the first cross street “52nd Street” and presses the “More” key. Then, the navigation system displays the key board screen of FIG. 7G through which the user inputs the name of the second cross street “59th Street”. Thus, the street name “Carson Street” and the two intersections on the street are specified in the foregoing process.

Since the place type of place name is not specified, when the user hits the “List” key, the navigation system displays the “Point of Interest” screen of FIG. 15D which lists “Select Place Type”, “Input Place Name” and “List All Places” to prompt the user to select one of them. Since the street name and two cross streets are already defined in the flow C above, the screen of FIG. 15D shows the street name “CARSON ST” although the two cross streets are not shown in this example.

When the user selects the “List all Places” menu in FIG. 15D, the navigation system lists all types of POIs on “Carson Street” between the 52nd street and 59th street as shown in FIG. 15E. The user selects his favorite restaurant “Macdonald” on “Carson Street” within the 52nd street and 59th street as shown in FIG. 15E. Then, the navigation system displays a “Confirm Destination” screen as shown in FIG. 15F to confirm the final destination. When the “OK to Proceed” menu is selected, the navigation system calculates the route to the destination and moves to the route guidance mode.

As has been described above, according to the present invention, the vehicle navigation system enables the user to more effectively and easily find a POI to specify the destination by incorporating the search-by-street method in the POI search process. Because the user can designate a street name, a city name, and two intersecting streets during the search process, he can quickly access a POI list which contains the desired POI. The search-by-street process can be used in various stages of the POI search process. Thus, the user can choose the search-by-street method any time based on the specific situation of search. Even if the user does not designate a place type or a place name but specifies a street name or other parameters (city name, cross streets) in addition to the street name, he can find the intended POI quickly and easily.

Although the invention is described herein with reference to the preferred embodiments, one skilled in the art will readily appreciate that various modifications and variations may be made without departing from the spirit and the scope of the present invention. Such modifications and variations are considered to be within the purview and scope of the appended claims and their equivalents.

1. A point of interest (POI) search method for a navigation system, comprising the following steps of:
starting a POI search process with use of a POI database where POIs are selectable by specifying either a place type or a place name;
specifying a name of a street to retrieve POIs located along the specified street; and
displaying a list of POIs retrieved along the specified street.

2. A point of interest (POI) search method as defined in claim 1, further comprising the step of specifying a type of POIs or a name of POI to be retrieved.

3. A point of interest (POI) search method as defined in claim 1, said step of specifying the name of the street includes a step of specifying a name of a city, thereby retrieving POIs along the specified street within the specified city.

4. A point of interest (POI) search method as defined in claim 1, said step of specifying the name of the street includes a step of selecting whether to retrieve POIs along an entire range of the specified street or to retrieve POIs along the specified street within a city specified by the user.

5. A point of interest (POI) search method as defined in claim 1, said step of specifying the name of the street includes a step of specifying a first intersection of the street and a second intersection of the street, thereby retrieving POIs along the specified street between the first and second intersections.

6. A point of interest (POI) search method as defined in claim 1, said step of specifying the name of the street includes a step of selecting whether to retrieve POIs along an entire range of the specified street or to retrieve POIs along the specified street between two intersections specified by the user.

7. A point of interest (POI) search method as defined in claim 1, said step of specifying the name of the street includes a step of selecting whether to retrieve POIs along an entire range of the specified street, to retrieve POIs along the specified street within a city specified by the user, or to retrieve POIs along the specified street between two intersections specified by the user.

8. A point of interest (POI) search method for a navigation system, comprising the following steps of:
starting a POI search process with use of a POI database where POIs are selectable by specifying either a place type or a place name;
performing a search-by-street process in which at least a name of a street is specified by the user;
retrieving POIs along the street specified by the user and displaying the POIs retrieved along the street to select one of them as a destination; and
determining a route to the destination and performing route guidance to the destination.

9. A point of interest (POI) search method as defined in claim 8, said step of performing the search-by-street process includes a step of specifying a name of a city, thereby retrieving POIs along the specified street within the specified city.

10. A point of interest (POI) search method as defined in claim 8, said step of performing the search-by-street process includes a step of specifying a first intersection of the street and a second intersection of the street, thereby retrieving POIs along the specified street between the first and second intersections.

11. A point of interest (POI) search apparatus for a navigation system, comprising:
means for starting a POI search process with use of a POI database where POIs are selectable by specifying either a place type or a place name;
means for specifying a name of a street to retrieve POIs located along the specified street; and
means for displaying a list of POIs retrieved along the specified street.

12. A point of interest (POI) search apparatus as defined in claim 11, further comprising means for specifying a type of POIs or a name of POI to be retrieved.

13. A point of interest (POI) search apparatus as defined in claim 11, said means for specifying the name of the street includes means for specifying a name of a city, thereby retrieving POIs along the specified street within the specified city.

14. A point of interest (POI) search apparatus as defined in claim 11, said means for specifying the name of the street includes means for selecting whether to retrieve POIs along an entire range of the specified street or to retrieve POIs along the specified street within a city specified by the user.

15. A point of interest (POI) search apparatus as defined in claim 11, said means for specifying the name of the street includes means for specifying a first intersection of the street and a second intersection of the street, thereby retrieving POIs along the specified street between the first and second intersections.

16. A point of interest (POI) search apparatus as defined in claim 11, said means for specifying the name of the street includes means for selecting whether to retrieve POIs along an entire range of the specified street or to retrieve POIs along the specified street between two intersections specified by the user.

17. A point of interest (POI) search apparatus as defined in claim 11, said means for specifying the name of the street includes means for selecting whether to retrieve POIs along an entire range of the specified street, to retrieve POIs along the specified street within a city specified by the user, or to retrieve POIs along the specified street between two intersections specified by the user.

18. A point of interest (POI) search apparatus for a navigation system, comprising:
means for starting a POI search process with use of a POI database where POIs are selectable by specifying either a place type or a place name;
means for performing a search-by-street process in which at least a name of a street is specified by the user;
means for retrieving POIs along the street specified by the user and displaying the POIs retrieved along the street to select one of them as a destination; and
means for determining a route to the destination and performing route guidance to the destination.

19. A point of interest (POI) search apparatus as defined in claim 18, said means for performing the search-by-street process includes means for specifying a name of a city, thereby retrieving POIs along the specified street within the specified city.

20. A point of interest (POI) search apparatus as defined in claim 18, said means for performing the search-by-street process includes means for specifying a first intersection of the street and a second intersection of the street, thereby retrieving POIs along the specified street between the first and second intersections.
